(19) United States
(12) Patent Application Publication
(10) Pub. No.: US 2021/0114139 A1
(43) Pub. Date: Apr. 22, 2021

(54) CONTROLLER, CONTROL SYSTEM, AND RECORDING MEDIUM STORING PROGRAM

(71) Applicant: FANUC CORPORATION, Yamanashi (JP)

(72) Inventor: Ryuutarou NISHIMURA, Yamanashi (JP)

(73) Assignee: FANUC CORPORATION, Yamanashi (JP)

(21) Appl. No.: 17/025,134

(22) Filed: Sep. 18, 2020

(30) Foreign Application Priority Data
Oct. 18, 2019 (JP) 2019-191130

(51) Int. Cl. B23K 26/082; B23K 26/38; B23K 26/03; B23K 26/06; B23K 26/70

(52) U.S. Cl. CPC B23K 26/082; B23K 26/38; B23K 26/03; B23K 26/705; B23K 26/0648; B23K 26/0626; B23K 26/0643

(57) ABSTRACT

A controller includes a machining information obtaining unit that obtains, as machining information, a machining result of the workpiece, the machining result being obtained by emitting the laser beam; a target value obtaining unit that obtains a target value of the machining result; a reference command value calculation unit that calculates, as a reference command value, a command value of an operation command for the laser machining device, based on the target value; a compensation amount determination unit that determines, based on the machining information and the target value, an amount of compensation for the laser beam; a compensated command value determination unit that determines a compensated command value by compensating for the reference command value, based on the reference command value and the amount of compensation; and an execution control unit that controls the laser machining device to emit the laser beam in accordance with the compensated command value.

This application is based on and claims the benefit of priority from Japanese Patent Application No. 2019-191130, filed on 18 Oct. 2019, the content of which is incorporated herein by reference.

### BACKGROUND OF THE INVENTION

### Field of the Invention

The present disclosure relates to a controller, a control system, and a recording medium storing a program.

### Related Art

A conventionally known laser machining device emits a laser beam to a workpiece to perform machining on the workpiece. The laser machining device emits the laser beam to the workpiece to melt the workpiece at an emission position to perform machining such as cutting and welding.

Some laser machining devices are capable of changing an emission angle relative to the optical axis of the laser beam. For example, a 3D galvanometer scanner changes the angle of mirrors to change the emission position (emission angle) at which the laser beam output from a light source and then reflected is to be emitted to the workpiece.

At the emission position of the laser beam, the beam shape is more significantly distorted from a perfect circle as the deviation from a position facing a laser beam output port of the laser machining device increases. For example, the beam shape is more significantly distorted into an ellipse as the deviation from the facing position increases. The beam shape is distorted for the machining of a workpiece having a curved-line section compared with the machining of a workpiece having a straight-line section. It is therefore difficult to provide uniform machining of workpieces. To address this issue, a laser beam scanning device has been proposed (see, for example, Patent Document 1) that compensates for the rotation angle of a galvanometer scanner on the basis of the target position for emitting a laser beam.

Patent Document 1: Japanese Unexamined Patent Application, Publication No. 2008-216873

### SUMMARY OF THE INVENTION

In the laser beam scanning device described in Patent Document 1, a target position for emitting a laser beam is input in advance to calculate an amount of compensation for a compensation position. In the laser beam scanning device described in Patent Document 1, a laser beam spot diameter is designated. In the laser beam scanning device described in Patent Document 1, the rotation angles of an X-axis galvanometer scanner, a Y-axis galvanometer scanner, and a Z-axis galvanometer scanner are determined on the basis of the amount of compensation for the compensation position and the laser beam spot diameter. The laser beam scanning device described in Patent Document 1 can thus easily optimize machining.

In Patent Document 1, however, it is difficult to compensate for a condition for emission of a laser beam in accordance with the actual machining circumstances. To achieve further optimization, it is desirable to compensate for a condition for emission of a laser beam by using the actual machining circumstances.

(1) In one aspect, the present disclosure provides a controller for controlling an operation of a laser machining device capable of changing an emission angle of a laser beam to be emitted to a workpiece, the controller including a machining information obtaining unit that obtains, as machining information, a machining result of the workpiece, the machining result being obtained by emitting the laser beam to the workpiece; a target value obtaining unit that obtains a target value of the machining result; a reference command value calculation unit that calculates, as a reference command value, a command value of an operation command for the laser machining device, based on the obtained target value; a compensation amount determination unit that determines, based on the obtained machining information and the obtained target value, an amount of compensation for the laser beam; a compensated command value determination unit that determines a compensated command value by compensating for the reference command value, based on the calculated reference command value and the determined amount of compensation; and an execution control unit that controls the laser machining device to emit the laser beam in accordance with the determined compensated command value.

(2) In another aspect, the present disclosure provides a control system includes the controller according to (1) above; and a sensor that outputs, as machining information, a machining result of the workpiece, the machining result being obtained by the laser machining device.

(3) In still another aspect, the present disclosure provides a recording medium storing a program for causing a computer to function as a controller for controlling an operation of a laser machining device capable of changing an emission angle of a laser beam to be emitted to a workpiece, the program causing the computer to function as a machining information obtaining unit that obtains, as machining information, a machining result of the workpiece, the machining result being obtained by emitting the laser beam to the workpiece; a target value obtaining unit that obtains a target value of the machining result; a reference command value calculation unit that calculates, as a reference command value, a command value of an operation command for the laser machining device, based on the obtained target value; a compensation amount determination unit that determines, based on the obtained machining information and the obtained target value, an amount of compensation for the laser beam; a compensated command value determination unit that determines a compensated command value by compensating for the reference command value, based on the calculated reference command value and the determined amount of compensation; and an execution control unit that controls the laser machining device to emit the laser beam in accordance with the determined compensated command value.

According to aspects of the present disclosure, it is possible to provide a controller, a control system, and a recording medium storing a program capable of compensating for a condition for emission of a laser beam by using the actual machining circumstances.

### BRIEF DESCRIPTION OF THE DRAWINGS

FIG. 1 is a schematic configuration diagram illustrating a 3D galvanometer scanner controlled by a control system according to an embodiment of the present disclosure.

FIG. 2 is a schematic plan view of a machining result of a workpiece that is machined by using the control system according to the embodiment.

FIG. 3 is a schematic configuration diagram illustrating the control system according to the embodiment.

FIG. 4 is a block diagram illustrating a controller according to the embodiment.

FIG. 5 is a schematic configuration diagram illustrating a configuration of a sensor according to a modification.

FIG. 6 is a schematic sectional view of a machining result obtained by performing machining on a workpiece according to a modification.

FIG. 7 is a graph illustrating a difference between a measured value of the machining result and a target value according to the modification.

FIG. 8 is a schematic diagram illustrating a relationship between a machining result and a bead width according to the modification.

### DETAILED DESCRIPTION OF THE INVENTION

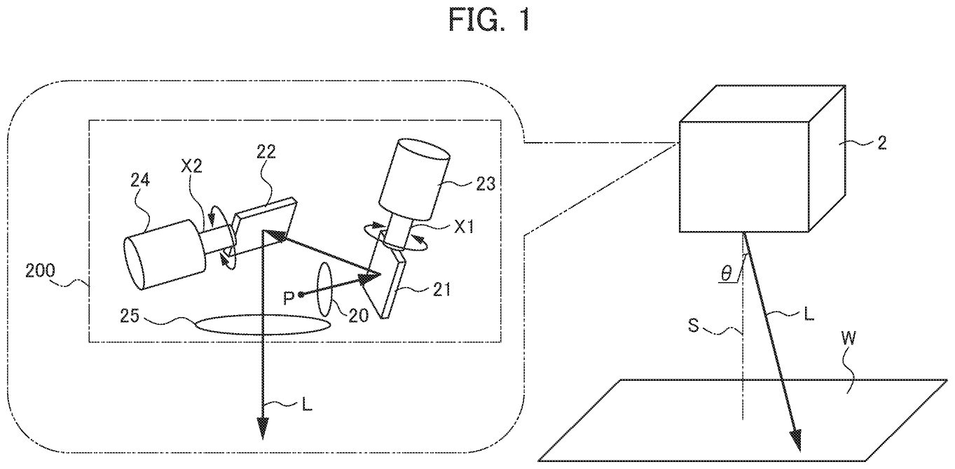

The following describes a controller 1, a control system 100, and a program according to an embodiment of the present disclosure with reference to FIGS. 1 to 4. Prior to the description of the controller 1, the control system 100, and the program according to the embodiment, a laser machining device 2 that is controlled by the controller 1, the control system 100, and the program will be described.

The laser machining device 2 is, for example, a galvanometer scanner. As illustrated in FIG. 1, the laser machining device 2 includes a focus lens 20 capable of adjusting the focal point of a laser beam L output from a laser beam source P, two mirrors 21 and 22 that sequentially reflect the laser beam L transmitted through the focus lens 20, two motors 23 and 24 that rotatably drive the mirrors 21 and 22 about rotary axes X1 and X2, respectively, and a focusing lens 25 that collects and outputs the laser beam L. The focus lens 20, the mirrors 21 and 22, the motors 23 and 24, and the focusing lens 25 constitute a laser beam output unit 200.

The focus lens 20 is configured to be movable between the laser beam source P and the mirror 21. The focus lens 20 moves between the laser beam source P and the mirror 21 to change the focal length. The focus lens 20 changes the focal length to change the beam diameter of the laser beam L to be emitted to a workpiece W.

The mirrors 21 and 22 are configured to be rotatable about the two rotary axes X1 and X2, which are perpendicular to each other, respectively. The motors 23 and 24, each of which is constituted by, for example, a servo motor, rotatably drive the mirrors 21 and 22, respectively, to scan the laser beam L output from the laser beam source P.

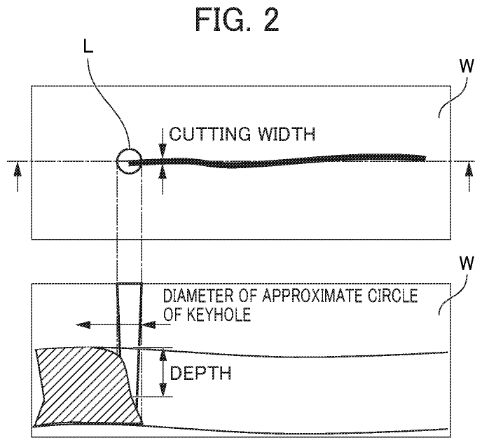

As illustrated in FIG. 1, the laser beam L output from the laser beam source P passes through the focus lens 20 and is sequentially reflected by the two mirrors 21 and 22. The laser beam L is collected by the focusing lens 25 and is emitted to the workpiece W. When the two mirrors 21 and 22 are rotatably driven by the motors 23 and 24, respectively, the incident angles of the laser beam L entering the mirrors 21 and 22 are successively changed. As a result, the laser beam L, which is sequentially reflected by the mirrors 21 and 22 and reaches the workpiece W, is scanned along a predetermined scan path on the workpiece W. Accordingly, as illustrated in FIG. 2, a groove having a predetermined cutting width and depth is formed in the workpiece W as a machining path.

The laser beam L output from the laser beam source P is emitted to the workpiece W at an emission angle θ relative to an optical axis S of the focusing lens 25 in accordance with the emission position. As the emission angle θ increases, the beam shape of the laser beam L to be emitted to the workpiece W becomes closer to an ellipse than to a perfect circle. Furthermore, the distance from a laser beam output port of the laser machining device 2 to an irradiation surface of the workpiece W is relatively long. The laser machining device 2 is capable of freely emitting the laser beam L over the range within which the laser beam L can be emitted. It is therefore difficult for the laser machining device 2 to perform relatively high precision machining such as for conventional gap control. Accordingly, the controller 1, the control system 100, and the program according to this embodiment are intended to compensate for machining conditions in accordance with actual machining results to reduce the variation on the machining results.

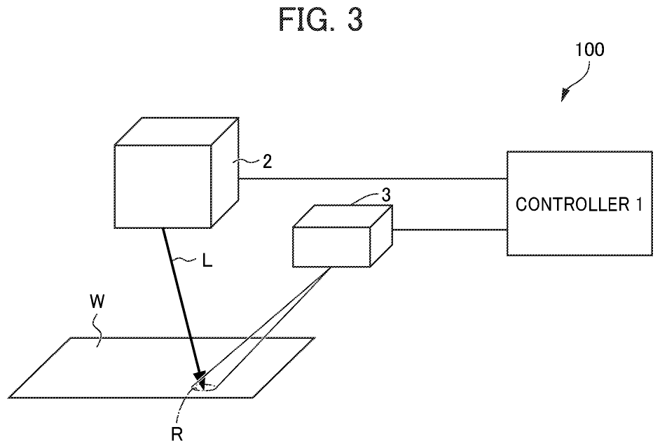

Next, the controller 1, the control system 100, and the program according to this embodiment will be described. As illustrated in FIG. 3, the control system 100 includes the laser machining device 2, a sensor 3, and the controller 1.

The laser machining device 2 is a device capable of emitting the laser beam L to the workpiece W. The laser machining device 2 emits the laser beam L to the workpiece W at an emission angle θ relative to the optical axis S of the focusing lens 25. A 3D galvanometer scanner is capable of, for example, cutting and welding the workpiece W. In this embodiment, the laser machining device 2 that cuts the workpiece W is described as an example.

The sensor 3 is, for example, a distance measurement sensor. The sensor 3 converts a machining result in a machining area R including the emission position of the laser beam L into a value and outputs the value. For example, the sensor 3 converts a distance measurement result of an area melted by the emitted laser beam L (near the emission position) into a value as a machining result and outputs the value. For example, the sensor 3 can output the physical quantity corresponding to the cutting width of the groove illustrated in FIG. 2. For example, the sensor 3 can further output the physical quantity corresponding to the depth of the groove illustrated in FIG. 2. The term “near the emission position”, as used here, refers to a location in the workpiece W where machining is actually performed by the emitted laser beam L, the location including the emission position.

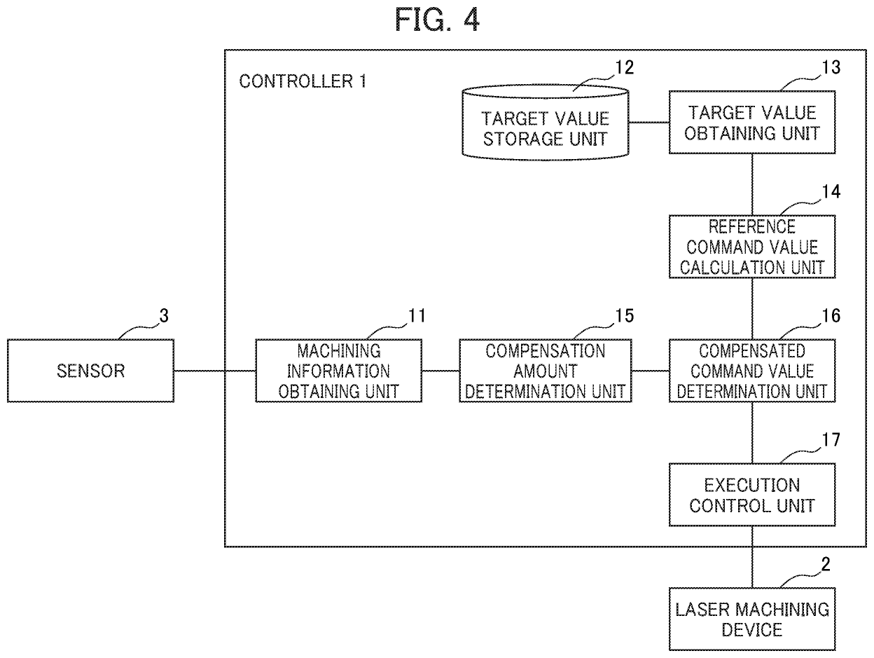

The controller 1 controls the operation of the laser machining device 2 capable of changing the emission angle θ of the laser beam L to be emitted to the workpiece W. As illustrated in FIG. 4, the controller 1 includes a machining information obtaining unit 11, a target value storage unit 12, a target value obtaining unit 13, a reference command value calculation unit 14, a compensation amount determination unit 15, a compensated command value determination unit 16, and an execution control unit 17.

The machining information obtaining unit 11 is implemented by, for example, an operation of a central processing unit (CPU). The machining information obtaining unit 11 obtains, as machining information, a machining result of the workpiece W, which is obtained by emitting the laser beam L to the workpiece W. The machining information obtaining unit 11 obtains, for example, the cutting width of a groove and the depth of the groove as machining information.

The target value storage unit 12 is, for example, a secondary recording medium such as a hard disk. The target value storage unit 12 stores a target value of a machining result. The target value storage unit 12 stores, as a target value, a value of the cutting position, the cutting width, the cutting amount, or the like for the workpiece W.

The target value obtaining unit 13 is implemented by, for example, an operation of the CPU. The target value obtaining unit 13 obtains a target value of a machining result. The target value obtaining unit 13 obtains a target value by, for example, reading the target value stored in the target value storage unit 12.

The reference command value calculation unit 14 is implemented by, for example, an operation of the CPU. The reference command value calculation unit 14 calculates, as a reference command value, a command value of an operation command for the laser machining device 2 on the basis of the obtained target value. For example, the reference command value calculation unit 14 analyzes the target value as a machining program. In accordance with the machining program, the reference command value calculation unit 14 calculates the energy density of the laser beam L, the acceleration/deceleration of the motors 23 and 24, the focal length, or the like as a reference command value.

The compensation amount determination unit 15 is implemented by, for example, an operation of the CPU. The compensation amount determination unit 15 determines an amount of compensation for the laser beam L on the basis of the obtained machining information and the obtained target value. For example, the compensation amount determination unit 15 calculates a difference between the machining information and the target value. The compensation amount determination unit 15 determines an amount of compensation of the energy density of the laser beam L, the acceleration/deceleration of the motors 23 and 24, the focal length (the amount of movement of the focus lens 20), or the like in accordance with the difference. Further, the compensation amount determination unit 15 determines a calculation result of Math. 1 below, which is represented by an amount of compensation ΔZ, by using a compensation direction (movement direction) S_{z} based on the current position, a conversion coefficient (machine position movement amount) C_{z}, a data weight Wᵢ, a target value aᵢ, and machining information mᵢ (e.g., the cutting width).

$$Δ Z = {s}_{z} \times {C}_{z} {\sum }_{i} {W}_{i} ( {a}_{i} - {m}_{i} ) \qquad [ Math . 1 ]$$

The compensated command value determination unit 16 is implemented by, for example, an operation of the CPU. The compensated command value determination unit 16 determines a compensated command value that is obtained by compensating for the reference command value on the basis of the calculated reference command value and the determined amount of compensation. For example, the compensated command value determination unit 16 calculates the sum of the reference command value and the amount of compensation to determine a compensated command value. The compensated command value determination unit 16 determines a calculation result of Math. 2 below, which is represented by a compensated command value Δ (laser command), by using a compensation direction S_{L} and a conversion coefficient α.

Δ(laser command)=s_{L}×α×ΔZ [Math. 2]

The execution control unit 17 is implemented by, for example, an operation of the CPU. The execution control unit 17 causes the laser machining device 2 to emit a laser beam on the basis of the determined compensation value. For example, the execution control unit 17 causes the laser machining device 2 to operate with the determined compensated command value.

Next, the operation of the control system 100 and the controller 1 will be described. First, the target value obtaining unit 13 obtains a target value from the target value storage unit 12. The reference command value calculation unit 14 calculates a reference command value on the basis of the target value. Since the laser beam L has not been emitted to the workpiece W in this stage, the sensor 3 does not output a machining result (machining information). Thus, the compensation amount determination unit 15 determines the amount of compensation to be 0. Accordingly, the compensated command value determination unit 16 determines only the reference command value as a compensated command value. The execution control unit 17 causes the laser machining device 2 to emit the laser beam L in accordance with the determined compensated command value.

In response to the emission of the laser beam L, the sensor 3 starts outputting machining information. The compensation amount determination unit 15 calculates a difference between the machining information and the target value. The compensation amount determination unit 15 converts the difference into the energy density of the laser beam L, the acceleration/deceleration of the motors 23 and 24, the focal length, or the like. The compensation amount determination unit 15 determines the converted value as an amount of compensation.

The compensated command value determination unit 16 calculates the sum of the reference command value and the amount of compensation to determine a compensated command value. For example, the compensated command value determination unit 16 determines the energy density of the laser beam L, the acceleration/deceleration of the motors 23 and 24, and the focal length (the movement distance of the focus lens 20), which is compensated for so that the amount of heat input into the emission position is kept nearly constant, as compensated command values. The execution control unit 17 controls the laser machining device 2 to perform laser emission in accordance with the compensated command value.

Next, the program according to this embodiment will be described. Each of the components included in the controller 1 can be implemented by hardware, software, or a combination thereof. The term “being implemented by software”, as used here, refers to being implemented by a computer reading and executing a program.

The program may be stored using various types of non-transitory computer readable media and supplied to a computer. The non-transitory computer readable media include various types of tangible storage media. Examples of the non-transitory computer readable media include magnetic recording media (e.g., a flexible disk, a magnetic tape, and a hard disk drive), magneto-optical recording media (e.g., a magneto-optical disk), a compact disc read only memory (CD-ROM), a CD-R, a CD-R/W, and semiconductor memories (e.g., a mask ROM, a programmable ROM (PROM), an erasable PROM (EPROM), a flash ROM, and a random access memory (RAM)). Alternatively, the program may be supplied to a computer through various types of transitory computer readable media. Examples of the transitory computer readable media include electrical signals, optical signals, and electromagnetic waves. A transitory computer readable medium can supply a program to a computer via a wired communication path such as an electric wire and an optical fiber or a wireless communication path.

Accordingly, the control system 100, the controller 1, and the program according to this embodiment achieve the following advantages.

(1) A controller 1 for control an operation of a laser machining device 2 capable of changing an emission angle of a laser beam L to be emitted to a workpiece W, the controller 1 including a machining information obtaining unit 11 that obtains, as machining information, a machining result of the workpiece W, the machining result being obtained by emitting the laser beam L to the workpiece W; a target value obtaining unit 13 that obtains a target value of the machining result; a reference command value calculation unit 14 that calculates, as a reference command value, a command value of an operation command for the laser machining device 2, based on the obtained target value; a compensation amount determination unit 15 that determines, based on the obtained machining information and the obtained target value, an amount of compensation for the laser beam L; a compensated command value determination unit 16 that determines a compensated command value by compensating for the reference command value, based on the calculated reference command value and the determined amount of compensation; and an execution control unit 17 that controls the laser machining device 2 to emit the laser beam L in accordance with the determined compensated command value. With this configuration, it is possible to compensate for a condition for emission of the laser beam L by using the actual machining circumstances. Accordingly, the amount of heat input into the emission position can be kept more nearly constant, and the machining circumstances can be stabilized.

(2) The machining information obtaining unit 11 obtains the machining information from a sensor 3 that converts a machining result in a machining area including an emission position of the laser beam into a value and outputs the value. With this configuration, it is possible to perform feedback control of a condition for emission of the laser beam L in accordance with the actual machining circumstances. Accordingly, unexpected emission circumstances can be dealt with flexibly. For example, even unexpected non-uniformities (irregularities) in a surface of the workpiece W can be dealt with flexibly.

(3) The reference command value calculation unit 14 calculates a reference command value including information on an angle of mirrors 21 and 22 that change an emission direction of the laser beam L, a position of a focus lens 20 that changes a focal length of the laser beam L, and an energy density of the laser beam L, the compensation amount determination unit 15 determines the angle of the mirrors 21 and 22 that change the emission direction of the laser beam L, the position of the focus lens 20 that changes the focal length of the laser beam L, and the energy density of the laser beam L, and the compensated command value determination unit 16 determines a compensated command value for the angle of the mirrors 21 and 22 that change the emission direction of the laser beam L, the position of the focus lens 20 that changes the focal length of the laser beam L, and the energy density of the laser beam L. With this configuration, it is possible to flexibly change the amount of heat input into the emission position.

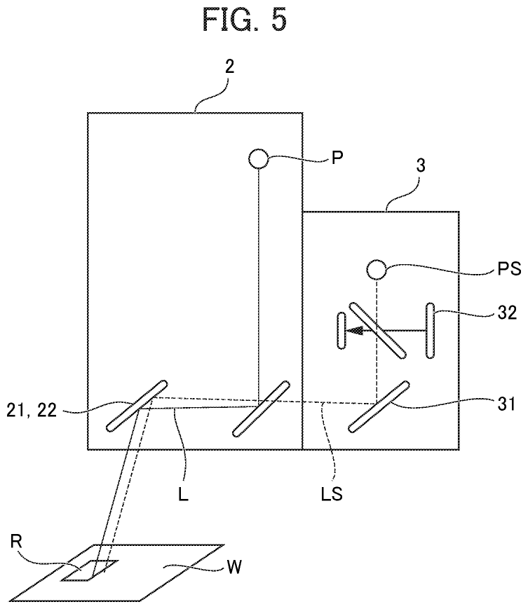

While a control system, a controller, and a program according to a preferred embodiment of the present disclosure have been described, the present disclosure is not limited to the embodiment described above and may be modified as appropriate. For example, in the embodiment described above, the sensor 3 may be formed as a coaxial sensor of the laser beam L of the laser machining device 2. Specifically, as illustrated in FIG. 5, the sensor 3 may reflect light output from a light source PS by using a sensor-side mirror 31 to produce distance measurement light LS, which is emitted to a machining surface of the workpiece W, reflect the distance measurement light LS by using the mirrors 21 and 22 of the laser machining device 2, and emit the distance measurement light LS to the machining area R of the workpiece W. Further, the sensor 3 may reflect the distance measurement light LS, which is reflected by the mirrors 21 and 22 of the laser machining device 2, by using the sensor-side mirror 31 and then receive the reflected distance measurement light LS by using a light-receiving unit 32. The sensor-side mirror 31 is capable of freely changing the angle so long as the distance measurement light LS can be emitted to the mirrors 21 and 22 of the laser machining device 2.

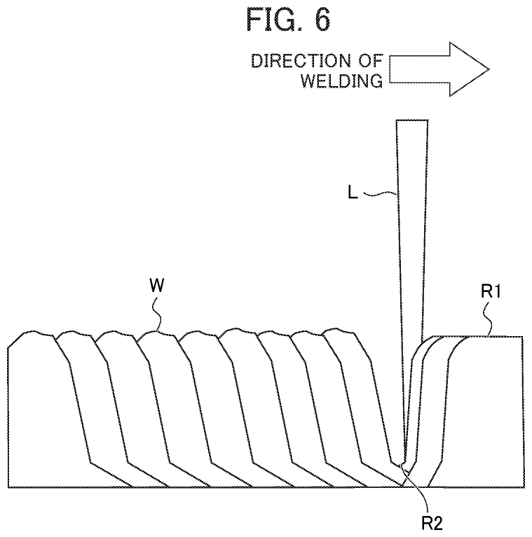

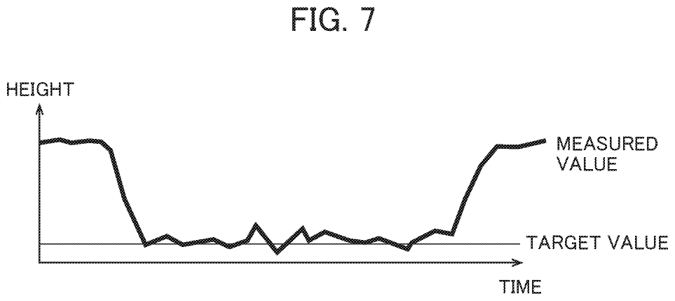

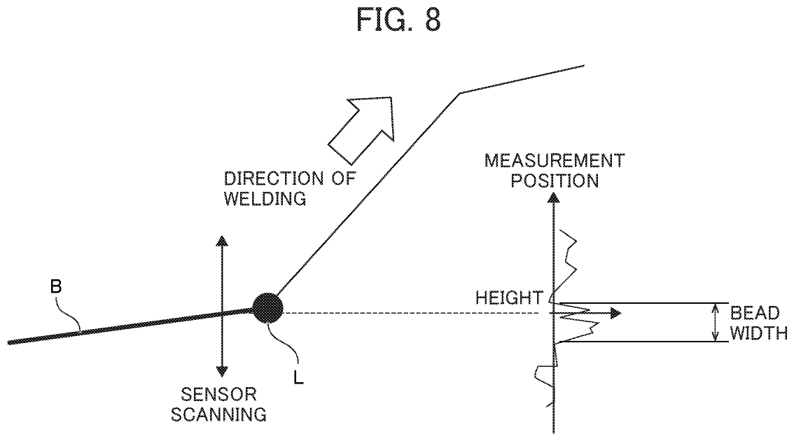

In the embodiment described above, machining is not limited to cutting and may be welding. When machining is welding, as illustrated in FIGS. 6 and 7, the sensor 3 measures the depth of a keyhole diameter (piercing hole diameter) from a surface height R1 before machining and a height R2 of a hole in the workpiece W during welding (dissolution) relative to the direction of welding. The compensation amount determination unit 15 determines a compensation value so that the difference between the measured value and the target value becomes close to zero. Alternatively, as illustrated in FIG. 8, the sensor 3 may determine an amount of compensation in a way similar to that for the depth of a groove by using the width of a welding bead B formed by welding.

In the embodiment described above, furthermore, the laser machining device 2 is not limited to a 3D galvanometer scanner. In the embodiment described above, furthermore, the sensor 3 is not limited to a distance measurement sensor. The sensor 3 may be, for example, a laser range sensor or the like. Alternatively, the sensor 3 may output, as a machining result, a captured image including a position where machining is performed with the laser beam L. The controller 1 may further include, for example, a machining result calculation unit (not shown) that calculates the width of a groove and the height of the groove on the basis of the output captured image.

In the embodiment described above, furthermore, the compensation amount determination unit 15 may determine the amount of compensation for the laser beam L in accordance with the content of machining performed by the laser machining device 2 on the basis of weighted machining information and a target value. For example, when welding is performed by the laser machining device 2, the value of the cutting width included in obtained machining information is not required to determine the amount of compensation. Accordingly, the compensation amount determination unit 15 may set the weighting for the cutting width included in the machining information to 0 (disable the weighting) and determine the amount of compensation for the laser beam L on the basis of weighted machining information and a target value. The compensation amount determination unit 15 may obtain machining content from a machining content setting unit (not shown) disposed in the controller 1. The target value obtaining unit 13 may read a target value from the target value storage unit 12 on the basis of the machining content set by the machining content setting unit. The machining content setting unit may be, for example, an input device such as a keyboard. The machining content setting unit may obtain machining content that is set in accordance with a machining program for machining the workpiece W. The machining content setting unit may set a weighted parameter to be applied to the machining information in accordance with the machining content.

### EXPLANATION OF REFERENCE NUMERALS

1 controller
2 laser machining device
3 sensor
11 machining information obtaining unit
13 target value obtaining unit
14 reference command value calculation unit
15 compensation amount determination unit
16 compensated command value determination unit
17 execution control unit
20 focus lens
100 control system
L laser beam
W workpiece

What is claimed is:

1. A controller for controlling an operation of a laser machining device capable of changing an emission angle of a laser beam to be emitted to a workpiece, the controller comprising:
a machining information obtaining unit that obtains, as machining information, a machining result of the workpiece, the machining result being obtained by emitting the laser beam to the workpiece;
a target value obtaining unit that obtains a target value of the machining result;
a reference command value calculation unit that calculates, as a reference command value, a command value of an operation command for the laser machining device, based on the obtained target value;
a compensation amount determination unit that determines, based on the obtained machining information and the obtained target value, an amount of compensation for the laser beam;
a compensated command value determination unit that determines a compensated command value by compensating for the reference command value, based on the calculated reference command value and the determined amount of compensation; and
an execution control unit that controls the laser machining device to emit the laser beam in accordance with the determined compensated command value.

2. The controller according to claim 1, wherein the machining information obtaining unit obtains the machining information from a sensor that converts a machining result in a machining area including an emission position of the laser beam into a value and outputs the value.

3. The controller according to claim 1, wherein the reference command value calculation unit calculates, as the reference command value, a reference command value including information on an angle of a mirror that changes an emission direction of the laser beam, a position of a focus lens that changes a focal length of the laser beam, and an energy density of the laser beam,
the compensation amount determination unit determines the angle of the mirror that changes the emission direction of the laser beam, the position of the focus lens that changes the focal length of the laser beam, and the energy density of the laser beam, and
the compensated command value determination unit determines a compensated command value for the angle of the mirror that changes the emission direction of the laser beam, the position of the focus lens that changes the focal length of the laser beam, and the energy density of the laser beam.

4. The controller according to claim 1, wherein the laser machining device comprises a 3D galvanometer scanner.

5. A control system comprising:
the controller according to claim 1; and
a sensor that outputs, as machining information, a machining result of the workpiece, the machining result being obtained by the laser machining device.

6. A recording medium storing a program for causing a computer to function as a controller for controlling an operation of a laser machining device capable of changing an emission angle of a laser beam to be emitted to a workpiece,
the program causing the computer to function as:
a machining information obtaining unit that obtains, as machining information, a machining result of the workpiece, the machining result being obtained by emitting the laser beam to the workpiece;
a target value obtaining unit that obtains a target value of the machining result;
a reference command value calculation unit that calculates, as a reference command value, a command value of an operation command for the laser machining device, based on the obtained target value;
a compensation amount determination unit that determines, based on the obtained machining information and the obtained target value, an amount of compensation for the laser beam;
a compensated command value determination unit that determines a compensated command value by compensating for the reference command value, based on the calculated reference command value and the determined amount of compensation; and
an execution control unit that controls the laser machining device to emit the laser beam in accordance with the determined compensated command value.
